(19) United States
(12) Patent Application Publication
(10) Pub. No.: US 2011/0081277 A1
(43) Pub. Date: Apr. 7, 2011

(54) REGENERATIVE THERMAL OXIDISER

(76) Inventors: Thomas Hamilton Balon, JR., Pembroke, NH (US); Neil Butler, Peterborough (GB)

(21) Appl. No.: 12/573,783

(22) Filed: Oct. 5, 2009

(51) Int. Cl. F23G 7/06; B01D 53/34; F28F 7/00; F16K 5/00; B21D 53/02

(52) U.S. Cl. 422/175; 165/185; 251/304; 29/890.03; 29/592

(57) ABSTRACT

A heat exchanger for a regenerative thermal oxidiser is described. The heat exchanger has a heat exchange bed that is disposed within a housing. The heat exchange bed is disposed parallel to the longest axis of the housing. A cavity is formed at either side of the heat exchange bed. Channels in the heat exchange bed link the two cavities. Because the heat exchange bed is disposed parallel to the longest axis of the housing, the area of the heat exchange bed facing the cavities is maximised, and the length of the channels is minimised, this reduces the pressure required to drive gas through the heat exchanger.

The present invention relates to regenerative thermal oxidisers and, in particular, to regenerative thermal oxidisers for the oxidisation of ventilated air methane.

The potential effects of global warming have been widely reported and much attention is currently given to mitigating such effects by reducing emissions of greenhouse gases. While carbon dioxide is the largest contributor to the greenhouse effect, methane is recognised as a greenhouse gas having a Global Warming Potential 21 times greater than that of carbon dioxide. The mitigation of methane emissions therefore presents an opportunity to reduce the impact of a potent greenhouse gas.

One of the largest sources of methane emissions into the atmosphere is the emission of mine ventilation air, containing dilute ventilation air methane (VAM) drawn from coal mines for safety reasons. The oxidation of this VAM to form carbon dioxide reduces its potency as a greenhouse gas. The oxidation or combustion of VAM therefore has a beneficial impact. The gas ventilated from coal mines typically contains very low concentrations of methane (0% to 1.25% by volume). In order to oxidise such low concentrations of methane the gas must be heated to at least the auto-ignition temperature of methane which is 1076 F (approximately 580 C).

A regenerative thermal oxidiser can be used to combust VAM. In a regenerative thermal oxidiser, the output heat from an oxidation reaction is used to pre-heat incoming gases. This is achieved by periodically switching the direction of airflow through the regenerative thermal oxidiser. The functioning of the regenerative thermal oxidiser can be controlled so that the operation of the regenerative thermal oxidiser is thermally self sustaining. That is, the core of the regenerative thermal oxidiser is maintained at a constant temperature with the heat generated by combustion of the gas being equal to the heat carried away and lost with the exhaust gas. Core temperatures of regenerative thermal oxidisers are typically in the range 1400 F (760 C) to 1600 F (871 C).

As described above, a regenerative thermal oxidiser is typically in thermal equilibrium. In order for a regenerative thermal oxidiser to function and to control and maintain the equilibrium, a blower that forces air through the regenerative thermal oxidiser must be supplied with energy and the mechanism that controls the switching of the direction of airflow through the unit must be supplied with energy.

The beneficial effects of methane abatement are reduced by this energy requirement, since there is a carbon dioxide usage associated with the energy used. Further, the energy requirements increase the operating cost of methane abatement.

Regenerative thermal oxidisers are often bespoke designed for specific locations using custom designed and manufactured components. The transportation to site and the assembly of such a regenerative thermal oxidiser on site each require a large amount of effort and specialist skill.

It is an object of the present invention to address at least some of the issues discussed above.

According to an aspect of the present invention, a heat exchanger for a regenerative thermal oxidiser is provided. The heat exchanger comprises a housing that defines a chamber within a plurality of walls. A heat exchange bed is disposed within the chamber. A plurality of channels run through the heat exchange bed. As gas passes through the channels, heat is transferred between the gas and the heat exchange bed. If the gas is a hot exhaust gas produced from the oxidisation of, for example, VAM, the gas passing through the heat exchange bed heats the bed. If the bed has been so heated and a gas at a temperature lower than such gas is directed through it, the heat exchange bed heats the incoming gas. Thus, the heat exchanger can be used to transfer some of the heat generated from the oxidisation of VAM to the incoming mine gas.

The heat exchange bed is arranged in the chamber so that it is disposed along a plane parallel to the longest axis of the chamber. Within the chamber, there are cavities above and below the heat exchange bed. These cavities run substantially along the longest axis of the chamber.

This arrangement of the heat exchange bed within the chamber results in the heat exchange bed being thin; this contrasts with conventional heat exchange beds for regenerative thermal oxidisers of the same thermal mass that are relatively thick in profile. This thin bed profile substantially increases the airflow capacity of the heat exchanger and reduces the pressure required to force air through the heat exchanger. This reduced pressure requirement in turn reduces the energy requirements of a fan that forces the gas through the heat exchanger.

Thus, embodiments of the present invention facilitate the realisation of a more operationally efficient regenerative thermal oxidiser.

According to an embodiment of the present invention, the heat exchanger has a passive flow controller in at least one of the cavities above and below the heat exchange bed.

This passive flow controller distributes airflow across the heat exchange bed. This is advantageous since creating an even airflow across the heat exchange bed maximises the heat exchange between the passing air or gas and the heat exchange bed.

According to an embodiment of the present invention, the housing has first and second openings that connect to the cavities formed above and below the heat exchange bed.

According to an embodiment of the present invention, the first and second openings are in opposing walls of the housing.

According to an embodiment of the present invention, the passive flow controller is a protrusion that extends from an inner surface of the housing, adjacent to the second opening. The protrusion faces the heat exchange bed and acts to divert airflow entering the cavity through the second opening towards the heat exchange bed.

According to an embodiment of the present invention, the protrusion is substantially triangular in cross section.

According to an embodiment of the present invention, the protrusion extends substantially across the width of the second opening.

According to an embodiment of the present invention, the passive flow controller is a plurality of vanes which are located in the first cavity. The vanes redirect the horizontal airflow into the first cavity in a vertical direction through the channels in the heat exchange bed. The vanes may be arranged so that the further vanes are located from the first opening, the further the vanes extend into the first cavity.

According to an embodiment of the present invention, the housing comprises a shipping container.

The use of shipping containers to form the housing has a number of advantages. A regenerative thermal oxidiser with a modular structure can be realised. This improves manufacturing efficiency and lower cost. The containers themselves can be used to ship additional components related to the regenerative thermal oxidiser unit such as a blower, media for the heat exchange bed.

Different sizes of shipping container are available. This allows units to be manufactured to the same system design with only the size of the container being altered to achieve higher airflow ratings. This allows a larger or smaller heat exchange bed to be accommodated, which in turn allows the capacity of the regenerative thermal oxidiser to be adjusted without having to change the system design. This presents a saving in terms of design cost. Containers of any length can be used depending on the flow rating required.

Typical flow ratings in embodiments of the present invention are 300 cubic feet per minute per square foot of media. Therefore, a 20′ (6.10 m) container with 20′ (6.10 m)×8′ (2.44 m) external dimension, and 18′ (5.4 m)×6′ 6″ (1.95 m) internal dimension would have a bed cross sectional area of 117 square feet (10.53 m²) and a nominal flow rating of 35,000 cubic feet per minute (˜60,000 m³/hr). A 24′ (7.2 m) container would have a nominal rating of 42,900 cubic feet per minute (˜72,500 m³/hr), a 30 foot (9.12 m) container 54,600 cubic feet per minute (˜92,300 m³/hr), a 35 foot (10.5 m) container 64,350 cubic feet per minute (˜108,760 m³/hr).

Containers are available in 40 foot (12.19 m) and 45 foot (13.5 m) lengths; these may be used to incorporate components of a regenerative thermal oxidiser in addition to the heat exchanger, such as a combustion duct and a valve within the container so a 40′ (12.19 m) container could be used to achieve a fully integrated heat exchanger with a 30′ (9.12 m) heat exchange bed.

Further, shipping containers represent a low cost source of housings suitable with minimal modification for use in regenerative thermal oxidisers. The manufacturing of the shipping containers is done in bulk; therefore the materials can be purchased in bulk by the container manufacturers. This reduces the cost.

The modular structure means that a suitable regenerative thermal oxidiser for use at a specific coal mine can be quickly realised and implemented. The scale of the regenerative thermal oxidiser can be adjusted by adding extra modules according to the required airflow. Since the majority of the manufacture can be done offsite, the amount of time and expertise required for the on site assembly, installation and commissioning is reduced.

According to an embodiment of the present invention the housing of the heat exchanger defines a second chamber in addition to the chamber containing the heat exchange material. In an embodiment of the present invention, this chamber is a combustion chamber of a regenerative thermal oxidiser. By incorporating the combustion chamber in the housing of a heat exchange bed, the process of assembling the regenerative thermal oxidiser on site from components is further simplified. The second chamber may have a heating element located on an inner surface to heat the combustion chamber to an operational temperature.

According to an embodiment of the present invention, the heat exchange bed is formed from a number of ceramic blocks. The ceramic blocks have channels running through them to allow gas to pass through the heat exchange beds.

According to an embodiment of the present invention, some of the channels running through the ceramic blocks are connected together. This reduces the pressure required to force gas through the heat exchanger.

An example of such media is that manufactured by Lantec. The maximum face velocity for the Lantec media is about 400 cubic feet per minute per square foot, so a 24′ (7.2 m) container system could have a flow rate of up to about 55,000 cubic feet per minute or nearly 100,000 m³/hr, but the blower energy consumption would increase substantially from the optimum energy efficiency airflow of 35,000 cubic feet per minute design. The optimal efficiency is in the 300 to 350 cubic feet per minute per square foot range for VAM purposes.

According to an embodiment of the present invention, the ceramic blocks are stacked so the heat exchange bed may be thicker in regions close to the first and second openings than it is in a region in between. Such an arrangement serves to balance airflow across the bed.

According to an aspect of the present invention, a valve assembly for a regenerative thermal oxidiser is provided. The valve assembly has a housing that forms a valve chamber. The valve chamber has an inlet duct opening, an outlet duct opening that is opposite the inlet duct opening, a first heat exchange bed opening and a second heat exchange bed opening that is opposite the first heat exchange bed opening. A valve blade that is rotatable around the first axis is located in the valve chamber. The housing has a plurality of inwardly facing protrusions that limit the angular position of the valve blade between a first radial position and a second radial position. The protrusions are in contact with the valve blade when it is in said first or said second position. The contact between the protrusions and the valve blade prevents fluid flow from the inlet duct opening to the outlet duct opening.

This arrangement has the result that during switching, when the valve blade is in motion, it is not in contact with the walls of the housing. This reduces the energy and time required for switching and reduces wear on the valve blade and the housing.

Further, when the valve blade is positioned in a mid position, the inlet is connected to the outlet. This can be used for safety reasons with all VAM bypassing the heat exchange beds and none being exposed to a potential source of ignition. In this position, no VAM airflow passes through the unit heat transfer beds.

According to embodiments of the present invention, the valve assembly further comprises ducting to connect the valve to heat exchangers. Such a valve assembly forms a component for a regenerative thermal oxidiser.

According to an aspect of the present invention a regenerative thermal oxidiser is provided. The regenerative thermal oxidiser comprises two heat exchangers according to aspects of the present invention, an inlet, an outlet, a valve assembly operable to selectively connect the inlet to the first cavity of the one heat exchangers and the outlet to the first cavity of the other heat exchanger. The regenerative thermal oxidiser further comprises a combustion chamber connected to the second cavities of both of the heat exchangers.

Aspects of the present invention thus allow a modular regenerative thermal oxidiser to be realised.

The heat exchangers can be formed from containers. The combustion chamber duct can be external to the containers and bolted in place or can also be integrated within the containers themselves such that there is a penetration in the bottom of the top container and a matching penetration in the top of the bottom container that are mated together when the two units are stacked.

It is noted that the oxidation or combustion occurs in the second chambers of the heat exchange beds as well as in the combustion chamber. Thus, a very large combustion chamber with increased residence time and improved destruction performance is realised.

It is noted that the dual use of containers as heat exchangers and combustion chambers in a stacked arrangement with parallel air flows dramatically reduces the footprint area of the oxidiser installation, thereby allowing more oxidiser units to be installed for a given fixed area than would be the case in a conventional oxidiser design, or alternatively less occupied land area for a given airflow than would be the case for a conventional oxidiser design.

The valve assembly may be realised according to an aspect of the present invention as described above. Such a valve assembly allows fast and efficient switching. This increases destruction ratios and reduces the energy required to operate the regenerative thermal oxidiser.

According to an embodiment of the present invention, the heat exchangers have a passive flow controller in at least one of the cavities above and below the heat exchange beds.

According to an embodiment of the present invention, the regenerative thermal oxidiser further comprises an active flow controller.

The active and passive flow controllers are advantageous an they enable the airflow to be balanced across the heat exchange beds. This maximises heat exchange between passing air or gas and the heat exchange beds.

According to an embodiment of the present invention, the combustion chamber is pre-heated using a diesel fired heater.

According to an embodiment of the present invention, the active flow controller is a fan connected to the inlet to force air through the heat exchangers. The fan has a variable drive speed. This allows active flow balancing of airflow through the regenerative thermal oxidiser.

According to an aspect of the present invention a method of manufacture of a heat exchanger from a shipping container is provided.

According to an aspect of the present invention a method of manufacture of a regenerative thermal oxidiser from shipping containers is provided.

### BRIEF DESCRIPTION OF THE DRAWINGS

In the following, embodiments of the present invention will be described as examples with reference to the figures in which:

FIG. 1 shows a regenerative thermal oxidizer;

FIG. 2 shows detail of a valve assembly and two heat exchangers;

FIG. 3 shows a regenerative thermal oxidizer;

FIG. 4A shows detail of a valve and associated ducts;

FIG. 4B shows an alternative valve arrangement;

FIG. 5 shows an end view of the valve and associated ducting;

FIG. 6 shows an outlet duct;

FIG. 7 shows detail of a heat exchanger;

FIG. 8 shows a regenerative thermal oxidiser;

FIG. 9 shows a regenerative thermal oxidiser;

FIG. 10 shows a top view of the regenerative thermal oxidiser shown in FIG. 9;

FIG. 11 shows a flowchart illustrating a method of manufacture of a heat exchanger; and;

FIG. 12 shows a flowchart illustrating a method of manufacture of a regenerative thermal oxidiser.

### DETAILED DESCRIPTION

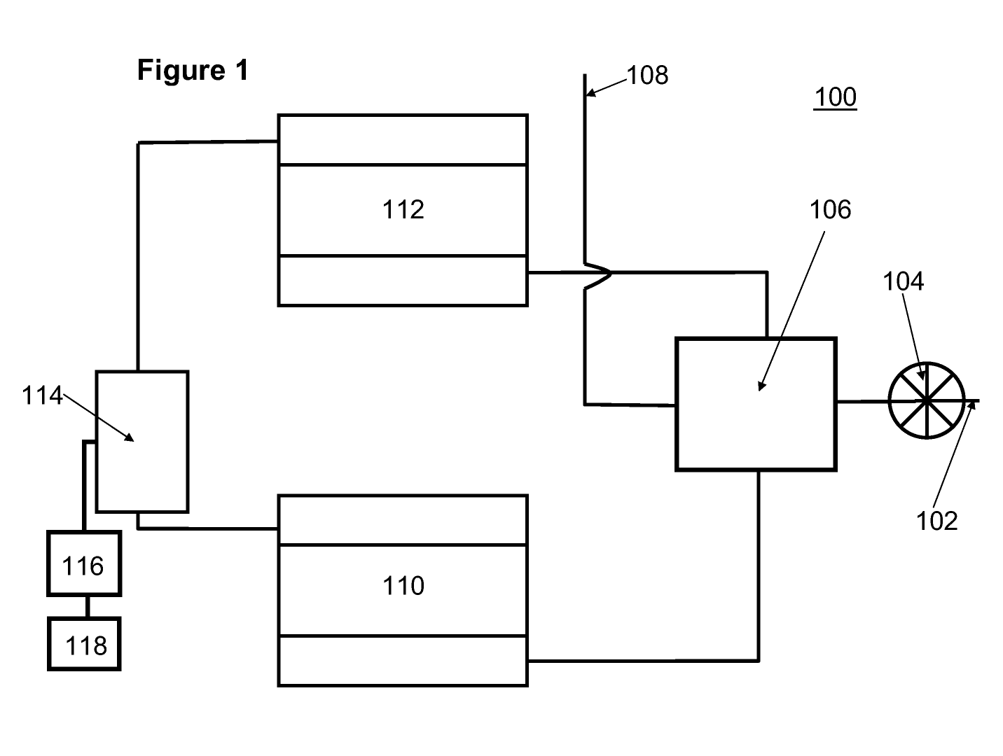

FIG. 1 shows a regenerative thermal oxidizer 100 according to an embodiment of the present invention. The regenerative thermal oxidizer 100 has an inlet 102 connected to a fan 104. The output from the fan is connected to a valve assembly 106. The valve assembly has connections to a vent 108 and two heat exchangers 110, 112 each of the heat exchangers have a heat exchange bed. A combustion chamber 114 is connected between the two heat exchangers. A heater 116 is located within the combustion chamber 114. A fuel supply 118 is connected to the heater 116.

The regenerative thermal oxidiser 100 uses heat generated during oxidisation of a pollutant in air contaminated with the pollutant to heat one of the heat exchangers. Later, incoming gas containing air and the pollutant is fed through that heat exchanger and the heat exchange bed within it, and the heat from the oxidisation is transferred from the incoming heat exchange bed to the incoming gas. By alternating the flow of the incoming gas between the two heat exchangers, the heat generated from the oxidisation reaction is contained within the combustion chamber of the unit, bounded by the two heat exchange beds and used to consistently pre-heat the incoming gas to a level above the auto-ignition temperature for the contaminant, methane in the case of VAM.

The operation of the regenerative thermal oxidizer 100 will now be described with reference to FIG. 1. A gas containing air and a pollutant to be cleaned is input into the inlet 102. The pollutant can be methane or another volatile organic compound. The fan 104 slightly pressurizes the incoming gas to enable its passage through the regenerative thermal oxidiser 100. The valve assembly 106 directs the incoming gas into the lower heat exchanger 110. The incoming gas is heated by the lower heat exchanger 110 and enters the combustion chamber 114. The pollutant is oxidized in the combustion chamber 114 and the heated exhaust air travels into the upper heat exchanger 112. As the exhaust air passes through the upper heat exchanger 112, it deposits heat into a heat exchange material within the upper heat exchanger 112. After travelling through the upper heat exchanger 112, the air with the pollutant removed is directed by the valve assembly 106 to the vent 108 which releases the cleaned air into the atmosphere.

The incoming gas thus is heated by the lower heat exchanger 110 and deposits heat into the upper heat exchanger 112. This process effectively cools the lower heat exchanger 110 and heats the upper heat exchanger 112. After a predetermined length of time has passed, the valve assembly 106 reverses the direction of flow of incoming gas so that it first passes through upper heat exchanger 112 which has now been heated and then the pollutant is combusted in the combustion chamber 114. The heated exhaust air then travels through the lower heat exchanger 110 and deposits a majority of its heat into a heat exchange material within the heat exchanger 110.

The regenerative thermal oxidizer 100 thus recycles the heat generated in burning the pollutant by using this heat to increase the temperature of the incoming gas and ultimately to pre-heat the outgoing thermal bed. The heat exchange beds are initially heated by heater 116 using fuel or electricity from the fuel or electricity supply 118. If the core temperature remains constant, the energy contained in the incoming gas will exactly match the heat rejected by the unit in the form of heated exhaust air.

The heat exchange beds within the heat exchangers 110 and 112 are orientated in a plane parallel to the long axis of the housings of the heat exchangers 110 and 112. This results means that for a given mass, the heat exchange beds can be made relatively thin compared with heat exchange beds orientated differently. Making the beds thinner reduces the pressure required from the fan 104.

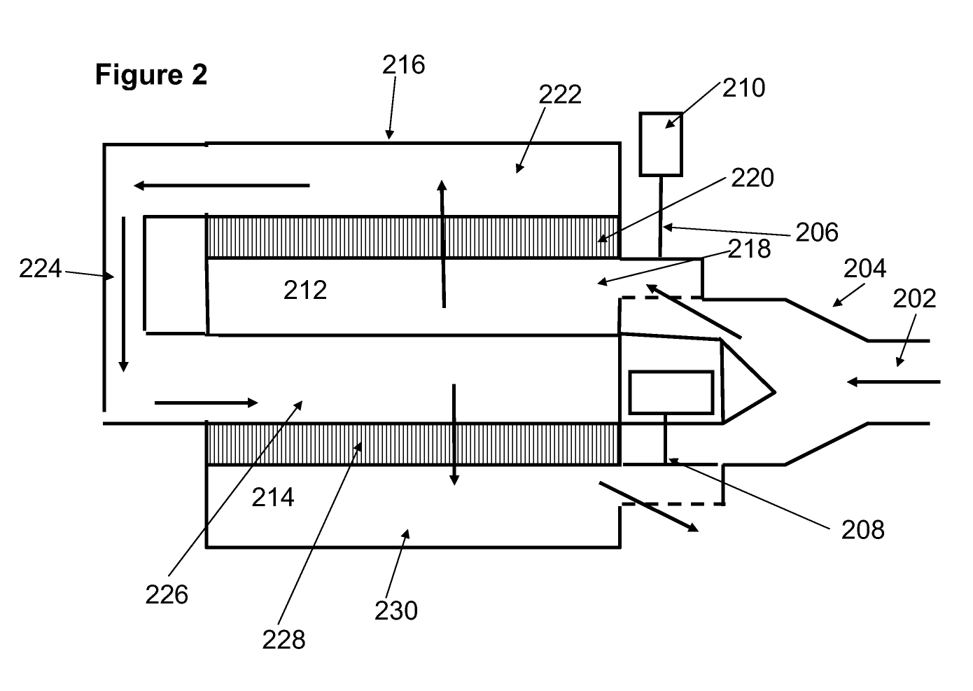

FIG. 2 shows detail of a valve assembly and two heat exchangers according to an embodiment of the present invention. Gas enters the regenerative thermal oxidizer 200 through an inlet 202. The inlet 202 is formed in an inlet duct 204. The inlet duct has connections to an upper poppet valve 206 and a lower poppet valve 208. The upper poppet valve 206 and the lower poppet valve 208 can be actuated by an actuator 210. The regenerative thermal oxidizer 200 has an upper heat exchanger 212 and a lower heat exchanger 214. The upper heat exchanger 212 is formed within a housing 216. When viewed from the side, the housing 216 is rectangular. The outlet from the upper poppet valve 206 connects to a cold side cavity 218 that runs along the bottom of the housing of the upper heat exchanger 216. Within the housing 216, the upper heat exchanger has a heat exchange bed 220 that is made from a material which absorbs heat from a passing hot gas and relinquishes heat to a passing cold gas. Above the heat exchange bed 220 there is a hot side cavity 222. The hot side cavity 222 runs the full length of the housing 216. The hot side cavity 222 connects to a combustion chamber 224. The combustion chamber 224 connects the hot side cavity of the upper heat exchanger 212 to the hot side cavity 226 of the lower heat exchanger 214. Below the hot side cavity 226 there is a heat exchange bed 228. Below the heat exchange bed 228 there is a cold side cavity 230. The cold side cavity 230 connects to the lower poppet valve 208.

In operation, the regenerative thermal oxidizer 200 receives input gas through the inlet 202. The input gas is directed by the poppet valves 202 and 208 into either the cold side cavity of the upper heat exchanger or the cold side cavity of the lower heat exchanger. The gas is then heated as it passes through the exchange bed in one of these heat exchangers. The heated gas then passes to the combustion chamber where it is oxidised and heat is liberated. The exhaust gas which carries the liberated heat then passes into the other of the heat exchanges. In the other heat exchanger, heat is deposited in the bed exchange material. The second poppet valve then directs the cooled exhaust gas to an outlet for release into the atmosphere.

It is noted that while the inlet and outlet plenums are referred to as cold side cavities the term cold is used in a relative sense. The cold side cavities are at ambient temperature when acting as an intake plenum but typically have temperatures of 300 F (149 C) to 400 F (204 C) when acting as an outlet plenum whereas the hot side cavities and combustion chamber have temperatures of 1400 F (760 C) to 1600 F (871 C).

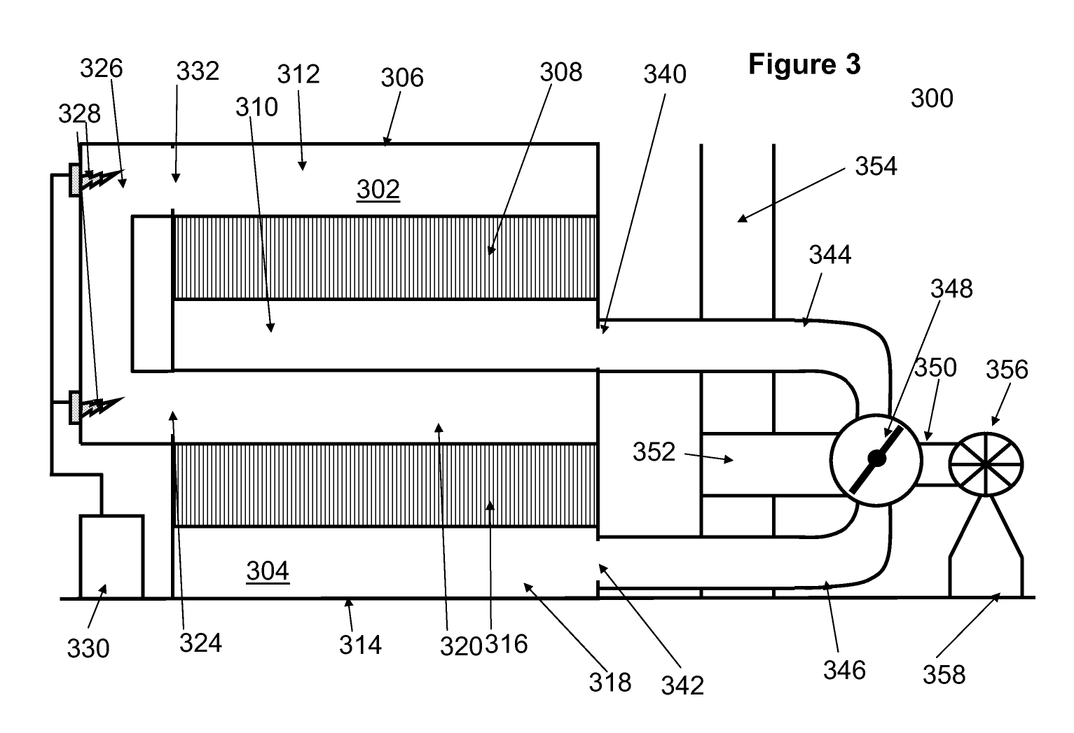

FIG. 3 shows a regenerative thermal oxidizer 300 according to an embodiment of the present invention. The regenerative thermal oxidizer 300 has an upper heat exchanger 302 and a lower heat exchanger 304. The upper heat exchanger 302 and the lower heat exchanger 304 are formed from shipping containers. The upper heat exchanger 302 is placed on top of the lower heat exchanger 304. The upper heat exchanger 302 has a housing 306 that is formed from a shipping container. The shipping container is modified by adding insulating material around the inside. The housing 306 is arranged horizontally. This allows the heat exchangers 302 and 304 to be stacked in the same way that shipping containers are stacked during transit. Within the housing 306, a heat exchange bed 308 is arranged as a horizontal layer that divides the chamber within the housing 306 into two cavities. The heat exchange bed 308 is formed from a number of blocks of ceramic material. Beneath the heat exchange bed 308 a cold side cavity is formed by the bottom of the heat exchange bed 308 and the bottom section of the housing 306. The cold side cavity 310 runs the full length of the housing 306. Above the heat exchange bed 308 there is a hot side cavity 312. This also runs the full length of the chamber formed by the housing 306.

Insulation is applied to at least the interior of the hot side cavity and adjacent to the thermal media, this makes the internal container dimensions of a standard 20 foot (6.06 m) container once insulated about 18 feet (5.49 m) long, 6.5 feet (1.98 m) in width and about 7.5 feet (2.29 m) high total. The lower cold plenum if not insulated is approximately 19′ (5.79 m)×7.5′ (2.29 m)×2.0′ (0.61 m). The heat exchange bed is typically 3 feet (0.91 m) thick nominal. The thickness of the heat exchange bed may vary along the length. The upper plenum is about 2.5 feet (0.76 m) high in a standard container. With tall containers the lower plenum would be increased to 2.5 feet (0.76 m) high and the upper combustion plenum increased to 3 feet (0.91 m).

The lower heat exchanger 304 has a similar structure to the upper heat exchanger 302. The lower heat exchanger has a housing 314 which is also formed from a shipping container. Within the housing 314 a horizontal heat exchange bed formed from a ceramic material divides the chamber formed by the housing into two cavities. The lower heat exchanger 304 has a cold side cavity 318 and a hot side cavity 320.

The upper heat exchanger 302 has an opening 322 in the housing 306 in a sidewall that links the hot side cavity to a combustion chamber 326. The lower heat exchanger 304 has a similar opening 324 in its housing 314. The combustion chamber 326 has one or two burners 328 which are connected to a diesel tank 330. The burners 328 are used to heat the heat exchangers 302 and 304 prior to using the regenerative thermal oxidizer 300.

While the fuel supply described above is diesel, other fuel sources such as bio-diesel, natural gas, LPG, distillate oil, propane and electricity can be used to initially heat the thermal heat exchange beds. The heaters heat the combustion chamber and the insides of the thermal beds. The thermal beds are not thermally conductive so the hot side can be 1600 F (871 C) while the cold side can be close to ambient at 70 F (21 C).

The cold side cavities 310 and 318 have openings 340 and 342 in the opposite end of the housing to the combustion chamber. An upper duct 344 connects to the opening 340 in the housing 306 of the upper heat exchanger 302. A lower duct 346 connects to the opening 342 of the lower heat exchanger 304. The upper duct 344 and the lower duct 346 connect to a rotary valve 348. The rotary valve 348 also connects to an inlet duct 350 and an outlet duct 352. The outlet duct 352 connects to a vent 354. The inlet duct 350 connects to a fan 356 which is in turned connected to an inlet 358.

The regenerative thermal oxidizer 300 is used to combust ventilated air methane from a coal mine as follows. The inlet 358 is connected to an air ventilation outlet from a coal mine. Thus, mine gas (comprising coal mine ventilation air containing ventilation air methane (VAM)) enters the regenerative thermal oxidizer 300. The fan 356 forces the mine gas into the regenerative thermal oxidizer 300. The rotary valve 348 controls the flow of incoming gas into either the upper heat exchanger 302 or the lower heat exchanger 304. In FIG. 3, the valve 348 directs incoming gas into the lower heat exchanger 304. The incoming gas enters the lower heat exchanger 304 after passing through duct 346. As the incoming gas passes through the heat exchange bed 316 of the lower heat exchanger 304, it is heated. The heat exchange bed 316 is heated from a previous cycle, and it is initially heated using the burners 328. As the incoming gas passes through the heat exchange bed 316, it is heated.

The hot gas then travels through the hot side cavity 320 of the lower heat exchange bed 304 and enters the combustion chamber 326 through the opening 324. The methane in the heated incoming gas is oxidized as it travels through the hot side cavities 320 and 312 and the combustion chamber 324. This releases additional heat. As the heated exhaust air passes through the heat exchange bed 308 of the upper heat exchanger 302, it deposits heat. The warm air then travels through the cold side cavity 310 of the upper heat exchange bed 302 and through the duct 344 back to the rotary valve 348. The rotary valve directs the air through the outlet duct 352 to the vent 354 from which it is released into the atmosphere.

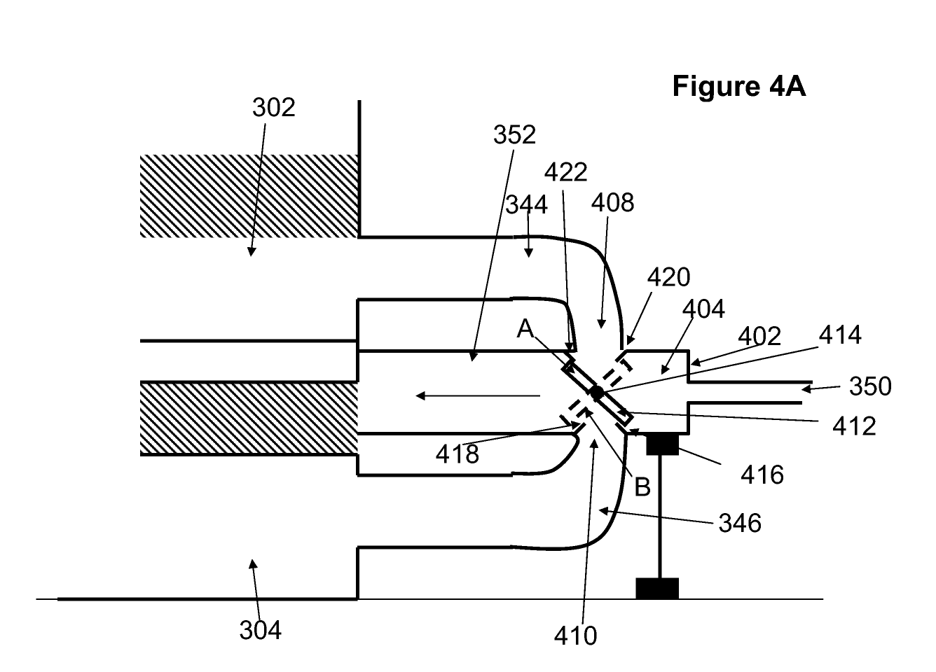

FIG. 4A shows the valve 348 and associated ducts in more detail. The valve 348 is formed within a housing 402. The housing 402 has an inlet duct opening 404 that connects to the inlet duct 350. Opposite the inlet duct opening there is an outlet duct opening 406. This connects to the outlet duct 352. The inlet duct opening 404 and the outlet duct opening 406 are located in the horizontal plane of the valve housing 402. The valve housing also has an upper heat exchange bed opening 408 located on its top side and a lower heat exchange bed opening 410 located on the bottom. Within the valve housing 402 a valve blade 412 is attached so that it can rotate around a pivot 414. The valve blade 412 is formed from a plate, the thickness of which does not vary substantially with the radial distance from the axis 414. Between each of the openings there is a rib that extends inwardly from the chamber wall that contacts the valve blade 412 and acts as a seal.

The ribs 416, 418, 420 and 422 restrict the angular positions of the valve blade 412 so that it can occupy a position A in which the rib 418 at the bottom left of the valve and the rib 420 at the top right of the valve are in contact with the valve blade 412. In this position, incoming gas is directed to the lower heat exchanger 304 and the gas coming out of the upper heat exchanger 302 is directed to the vent. The valve can move to a position B in which the valve blade is in contact with the rib 416 at the lower right corner and the rib 422 at the upper left corner. In this position, the incoming gas is directed into the upper heat exchanger and the outgoing gas from the lower heat exchanger is directed to the outlet duct 352. When the valve changes between these two positions, gas from the inlet 350 can travel straight through the valve to the outlet 352.

It is noted that for use in connection with mine ventilation, the feature that during changeover the inlet is connected to the outlet is a great advantage as this allows the mine to be continuously ventilated.

FIG. 4B shows an alternative valve arrangement 450 according to an embodiment of the present invention. The valve 450 has a housing 451 that is circular in cross section. The housing 451 has an inlet duct opening 404 and an outlet duct opening 406 opposite the inlet duct opening 404. The valve housing also has an upper heat exchange bed opening 408 located on its top side and a lower heat exchange bed opening 410 located on the bottom. The locations of the openings are analogous to those described above in reference to FIG. 4A.

A valve blade 452 is mounted on a pivot 414 running through the centre of the housing 451. The valve blade is formed from two plates 454 and 456 that are attached together so that both run through the pivot and one plate 454 is disposed at an angle of approximately 30 degrees from the other plate 456. The valve blade 542 therefore has a ‘bowtie’ shape. The valve blade 452 is narrow in the centre close to the pivot 414 and the width of the valve blade 452 increases linearly with radial distance from the pivot 414.

There are four seal ribs 416, 418, 420 and 422 that extend into the chamber formed by the housing 451. Two of the seal ribs 416 and 418 are located at either side of the lower heat exchange bed opening 410, and two of the seal ribs 420, 422 are located at either side of the upper heat exchange bed opening 408.

An optional brush seal 458 may be attached to the outwardly facing surface 460 joining the two plates 454 and 456. Similarly a brush seal 462 may be attached to the outwardly facing surface 464 on the opposite side of the valve blade 452.

The separation of the two plates 454 and 456 where is valve blade is adjacent to the housing 451 is approximately the same as the distance between the edge of the inlet duct opening 404 and the upper heat exchange bed opening 408. Thus, when one to the valve plates 454 of the valve blade 452 is in contact with the seal rib 420 located at the edge of the upper heat exchange bed opening 408, the other valve plate 456 is located close to the edge of the inlet duct opening 404.

The valve arrangement 450 shown in FIG. 4B with a bowtie shaped blade 452 exerts a constant load on the fan and thus results in a constant fan flow.

The distance between the valve plates 454 and 456 along the surfaces 460 and 464 that connect them is less than the width of the inlet opening 404 and the outlet opening 406. Thus the valve blade 452 can be moved to a horizontal position to allow airflow directly from the inlet duct opening 404 to the outlet duct opening 406. When the valve blade 452 is in a horizontal position the 30 degree angle leaves two small gaps above and below the valve blade 542. This partial blocking of the valve simulates the pressure of the media when the valve is in the horizontal position, reducing fluctuations in fan load during switching and also balancing electrical load consumed by the blower.

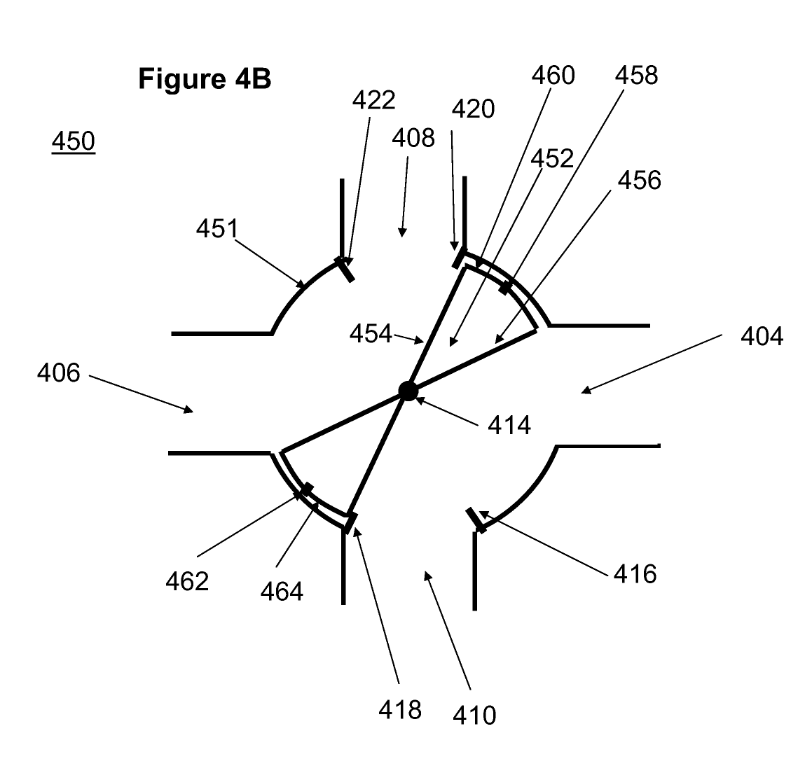

FIG. 5 shows an end view of the valve and associated ducting. The upper duct 344 and the lower duct 346 are respectively directly above and directly below the valve 348. The upper duct 344 connects to the upper heat exchanger 306 and the lower duct 346 connects to the lower heat exchanger 314. The vent 354 is located behind the plane of the valve and the upper and lower ducts. An actuator 502 is connected to the valve 348 and can cause the valve plate of the valve 348 to move.

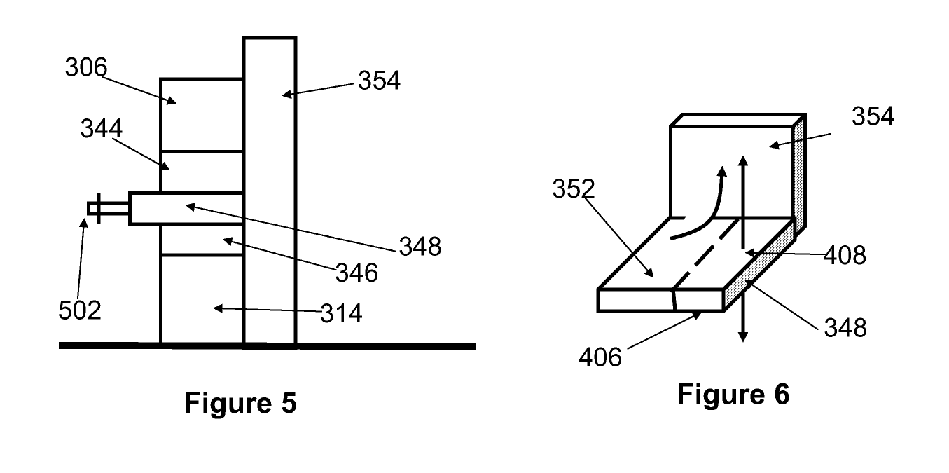

FIG. 6 shows the outlet duct 352. The outlet duct 352 runs laterally in the plane of the valve and the upper and lower ducts and connects to the vent 354 at the side. The upper heat exchange bed opening 408 is vertically above the valve 348 and the lower heat exchange bed opening 406 is vertically below the valve 348.

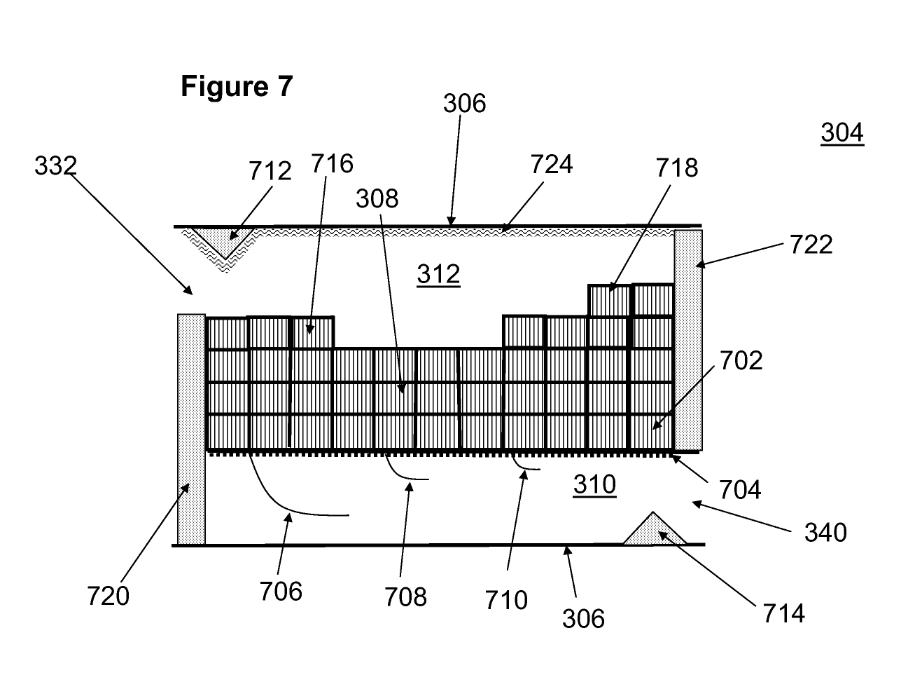

FIG. 7 shows the upper heat exchanger 304. End walls 722 and 720 are located at either end of the housing 306 of the heat exchanger and form the openings 332 and 340 to the combustion chamber and to the valve. The heat exchange bed 308 is formed from a number of blocks 702 of ceramic material. The blocks have channels running vertically through them to allow gas to pass through the heat exchange bed. The blocks may be, for example, ‘LanteComb® Heat Recovery Media’ supplied by Lantec Products Incorporated of Boston, Mass. Such media has an interconnected cell structure that requires a low pressure difference. There are a number of vertical channels running through the blocks 702. These channels are separated by walls formed form the ceramic material. There are gaps linking some of the channels running the full vertical length of the blocks. The blocks 702 are supported by a grate grid 704.

A number of conventional vanes 706, 708, 710 extend into the cold side cavity 310 from the grate grid 704. The vanes redirect the horizontal airflow coming into the cold side cavity upwards, in a vertical direction, into the heat exchange bed 308. The distance that the vanes extend into the cavity varies with the distance from the opening 340. Thus the vane 706 furthest from the opening 340 extends further into the cavity that the next furthest vane 708, which in turn extends further than the next vane 710. This arrangement of vanes assists in equalization of the gas flow across the area of the heat exchange bed 308.

Other appurtenances are also located in the hot side cavity of the upper heat exchanger to redirect the vertical gas flow from the heat exchange beds in a horizontal direction towards the opening to the combustion chamber. A triangular flow element 712 is attached to the top surface of the chamber formed by the housing 306. The triangular flow element is located adjacent to the opening 322 that links the hot side cavity to the combustion chamber. The triangular flow element is triangular in cross section and runs the width of the housing 306. The triangular flow element 712 balances the air flow across the heat exchange bed 308. A similar triangular flow element 714 is located adjacent to the opening 340 that connects the cold side cavity 310 to the inlet duct. The triangular flow elements 712 and 714 are fixed to the interior of the housing 306. The interior of the housing 306 that surrounds the hot side cavity 312 and the heat exchange bed 308 is covered with a layer of insulation 724. The layer of insulation covers the triangular flow element 712, but the shape of the element is maintained in the surface of the insulation layer 724.

The interior of the cold side cavity 310 may also be covered with insulation.

The ceramic blocks 702 are stacked so that there is an additional layer of blocks 716 in the hot side chamber 312, adjacent to the opening 332 to the combustion chamber. There are also an additional two layers of blocks 718 at the opposite side of the hot side cavity to the opening 332 to the combustion chamber.

The additional layers of blocks 716 and 718 and the triangular flow elements 712 and 714 balance the airflow across the ceramic bed 308.

The lower heat exchange bed also has analogous vanes, flow elements and stacking of ceramic blocks to balance flow in both the hot and cold side cavities.

In addition to the passive airflow management described above, the airflow through the regenerative thermal oxidiser is controlled actively by varying the drive frequency of the fan connected to the inlet. The airflow can be modified by plus or minus 20% using this method.

The techniques discussed above to balance airflow may be used separately but provide the best optimisation if used together. The curved vanes and triangular elements allow course adjustment, the fan control and media stacking allow finer flow control methods to help fine tune the regenerative thermal oxidiser.

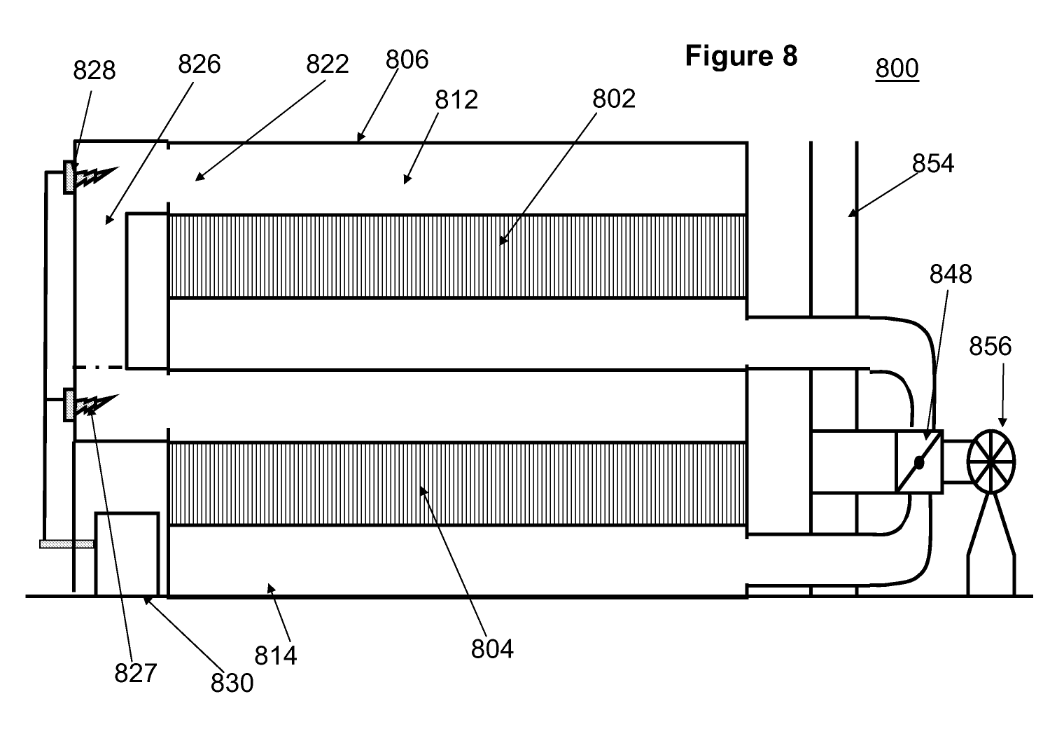

FIG. 8 shows a regenerative thermal oxidiser according to an embodiment of the present invention. The regenerative thermal oxidiser 800 has a fan 856 a valve 848 and a vent as described above in relation to FIGS. 3 to 6. The ducting connecting these parts of the regenerative thermal oxidizer 800 is also as described above in relation to FIGS. 3 to 6.

In the embodiment described above in reference to FIG. 3, a separate combustion chamber is required in addition to the upper and lower heat exchangers. In the regenerative thermal oxidiser 800 shown in FIG. 8, the combustion chamber 826 is located inside the container 806 that forms the housing of the upper heat exchanger 802. Thus, the housing 806 has a second chamber, a combustion chamber 826 that connects to the opening 822 from the hot side cavity 812. A burner 828 is located on the wall of the combustion chamber 826.

The combustion chamber 826 extends into the top corner of the lower heat exchanger 804. A second burner is located on the wall of the combustion chamber formed by the housing 814 of the lower heat exchanger. The housing 814 of the lower heat exchanger 804 has an additional chamber that houses a diesel fuel tank 830.

The arrangement described above allows the combustion chamber and diesel fuel tank to be prefabricated from shipping containers and reduces the expertise and time required for assembly of the regenerative thermal oxidiser on site.

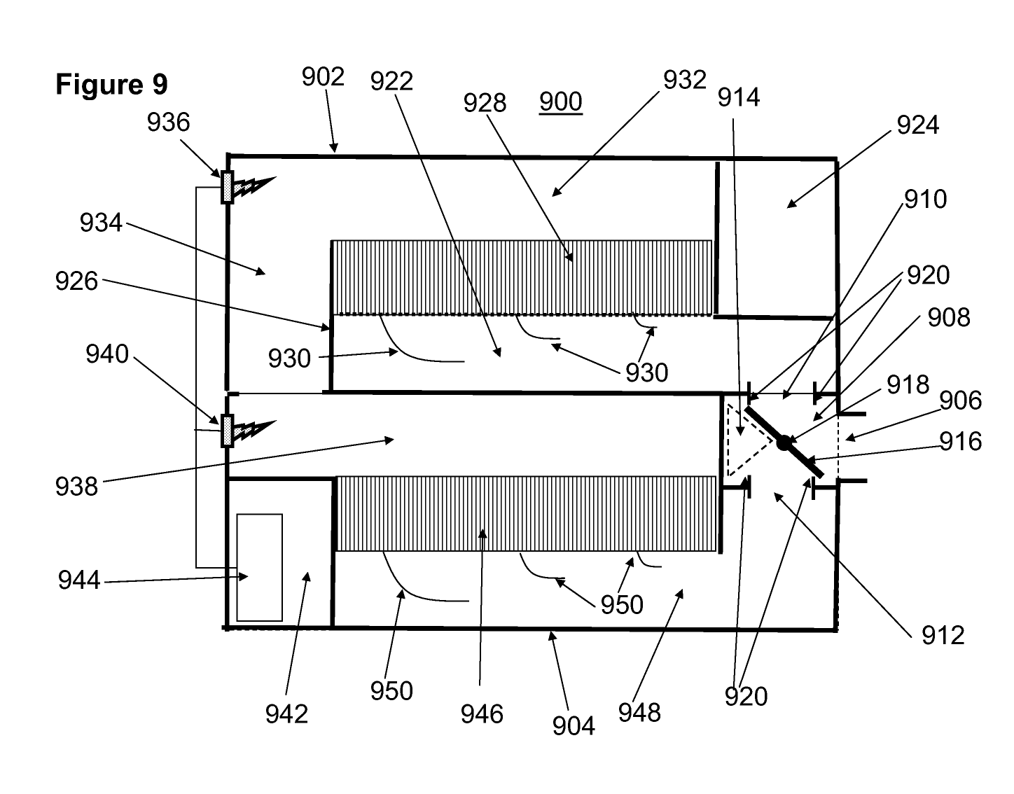

FIG. 9 shows a regenerative thermal oxidiser according to an embodiment of the present invention in which the valve assembly is integrated into the housing of the heat exchange beds.

The regenerative thermal oxidiser 900 is formed from an upper heat exchange bed module contained within a housing 902 formed from a shipping container, and a lower heat exchange bed module contained within a housing 904 that is also formed from a shipping container. The housing 904 of the lower heat exchange bed module has an inlet opening 906. The inlet opening 906 is formed in the end of the housing 904 of the lower heat exchange bed module. The opening is formed in an end plate added to the shipping container during modification. The end plates are described above with reference to FIG. 7.

The inlet opening 906 connects to a valve chamber 908 within the housing 904. The valve chamber 908 has an upper heat exchange bed opening 910 that connects upwards to an opening in the housing 902 of the upper heat exchange bed module. At the bottom of the valve chamber 908 there is a lower heat exchange bed opening 912. There are two outlet duct openings 914 in the sides of the housing 904. These connect to vents attached to the sides of the housing 904 of the lower heat exchange bed module.

A valve blade 916 is attached to a pivot 918 within the valve chamber 908. The rotational motion of the valve blade around the pivot 918 is limited by ribs 920 that protrude into the valve chamber from the edges of the upper heat exchange bed opening 910 and the lower heat exchange bed opening 912.

When the valve blade 916 is in contact with the ribs 920, a seal is formed. The valve blade 916 has two positions where a seal is formed: one (as shown in FIG. 9) where the inlet opening 906 is connected to the upper heat exchange bed opening 910, and the lower heat exchange bed opening 912 is connected to the outlet duct openings 914. In the second, the valve blade is rotated approximately 90 degrees so that the inlet opening 906 is connected to the lower heat exchange bed opening 912 and the upper heat exchange bed opening 910 is connected to the outlet duct openings 914.

The valve blade 916 can move between the positions described above through a position in which it is horizontal. When the valve blade 916 is in a horizontal position or in a position in which it is not in contact with the ribs 920, there is no seal formed and airflow from the inlet duct opening 906 directly to the outlet duct opening 914 is permitted.

The upper heat exchange bed opening 910 connects to the cold side cavity 922 of the upper heat exchange bed module. There is a compartment void 924 above the upper heat exchange bed opening 910. The compartment void 924 is located in the space in the housing 902 of the upper heat exchange bed module corresponding to the space occupied by the valve chamber 908 in the housing 904 of the lower heat exchange bed module.

The cold side cavity 922 of the upper heat exchange bed module extends along the bottom of the housing 902 approximately ⅘ of the length of the housing 902. A wall 926 forms the end of the cold side cavity 922 furthest from the upper heat exchange bed opening 910. A heat exchange bed 928 is located above the cold side cavity 922 between the compartment void 924 and the wall 926. The heat exchange bed 928 is formed from blocks of ceramic material as described above. A number of vanes 930 extend from the bottom of the heat exchange bed 928 into the cold side cavity 922.

A hot side cavity 932 is located above the heat exchange bed 928. One end of the hot side cavity 932 is formed by the wall of the compartment void 924. The other end of the hot side cavity is open and connects to a combustion chamber 934. The combustion chamber 934 occupies the full height of the housing 902 of the upper heat exchange bed module and extends into the housing 904 of the lower heat exchange bed module.

A burner 936 is located on the wall of the combustion chamber 934. The section of the combustion chamber 934 formed within the housing 904 of the lower heat exchange bed module connects to the hot side cavity 938 of the lower heat exchange bed module. A second burner 940 is located on the wall of this section of the combustion chamber 934.

Directly below the combustion chamber 934, in the housing 904 of the lower heat exchange bed module there is a compartment 942. A fuel supply may be housed within the compartment 944 and is connected by a fuel line to the burners 936 and 940

The compartment 944 may also be used to allow access, to store spare parts for the regenerative thermal oxidiser, to store the control system or as an oven for mine use.

Below the hot side cavity 938 a heat exchange bed 946 runs from the edge of the compartment 942 to the wall defining the side of the valve chamber 908. Below the heat exchange bed 946, there is a cold side cavity 948 that runs from the wall of the compartment 942 to the end wall of the housing 904 of the lower heat exchange bed module. The cold side cavity 948 connects to the lower heat exchange bed opening 912 of the valve chamber 908.

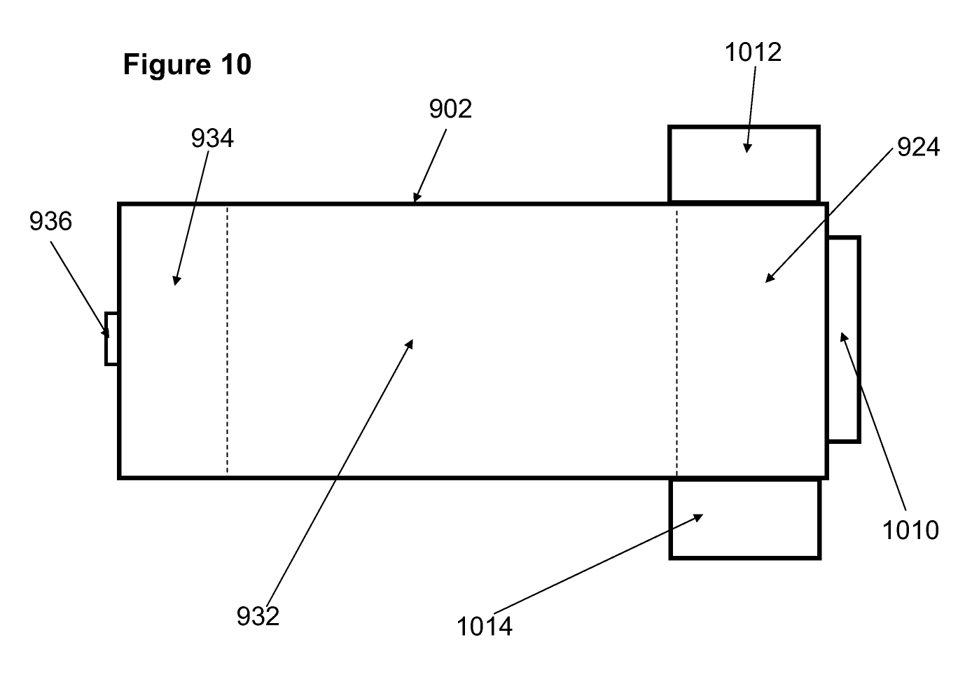

FIG. 10 shows a top view of the regenerative thermal oxidiser shown in FIG. 9 to illustrate the vents connected to the outlet ducts.

The outline of the housing 902 of the upper heat exchange bed module is shown from above. An inlet duct 1010 is connected to end of the housing of the lower heat exchange bed module that is directly below the housing 902 of the upper heat exchange bed module. The inlet duct 1010 connects to the inlet opening described above in reference to FIG. 9.

An exhaust vent 1012 is located at the side of the housing 902 close to the end where the inlet duct connects to the housing of the lower heat exchange bed module. A second exhaust vent 1014 is located on the opposite side of the housing 902. The two exhaust vents 1012 1014 are located in positions on the sides of the housing 902 that are approximately adjacent to the compartment void 924 within the chamber.

FIG. 10 also shows the locations of the hot side cavity 932 and the combustion chamber 934 within the housings 902. The external part of the burner 936 extends from the end of the housing 902 furthest from the exhaust vents 1012 1014 and the inlet duct 1010.

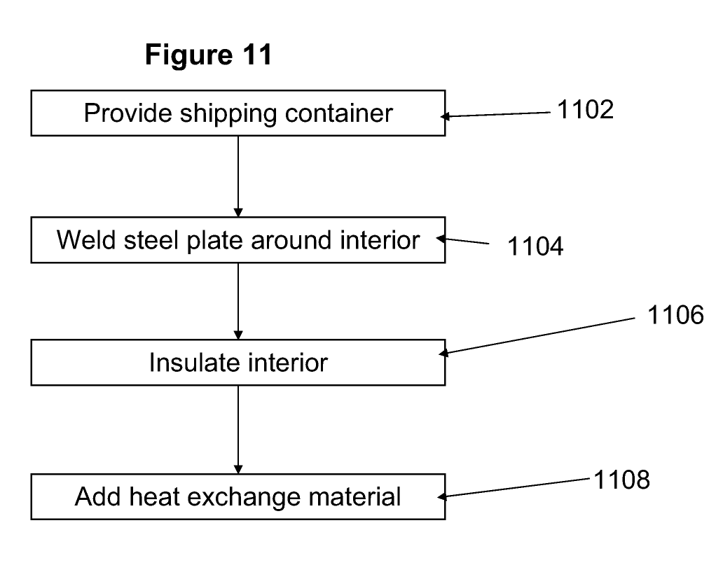

The modification of a shipping container to form a heat exchanger will now be described by reference to FIG. 11.

In step 1102 a shipping container is provided. The shipping container may be an ISO container that is 8.5 feet (2.74 m) high, 8 feet (2.44 m) wide, and has a length of 20 feet (6.10 m) or 40 feet (12.19 m). Alternatively it may be a ‘hi-cube’ container with a height of 9 feet 6 inches (2.90 m) or 10 feet six inches (3.20 m). Other sizes of shipping container may also be modified using the following method to form a heat exchanger.

The use of taller ‘hi-cube’ containers allows the heights of the hot and cold side cavities to be increased and thus air flow restriction can be reduced and air flow balanced.

In step 1104, steel plate is welded around the interior of the container form a thin internal skin and to provide a smooth interior surface. Prior to the welding of the steel plating, the wooden floor is removed from the shipping container. The waterproof sealing around the edging of the shipping container may be removed and replaced with a continuous steel weld.

Flanges to mount the end plates are welded to the interior inside the doors of the container. The doors retained so that when the doors are closed, the exterior of the container is unchanged. The doors of the container can be closed for transportation. When the heat exchanger is in use, the doors are opened to expose the end plates and to allow ducting to be connected to the openings in the end plates.

Once the container has been modified as described above, the support framework for the ceramic media, grate grid is installed. The triangular flow elements are added to the top and/or bottom surfaces of the container.

Then in step 1106, inner surface of the container is covered with an insulation layer such as 6″ (150 mm) thick rockwool. This insulation layer covers the triangular flow elements.

In step 1108, the heat exchange material is stacked inside the container. Steps 1102 to 1106 can be carried out before the modified container is shipped to the site where it is to be used. Since the heat exchange material is formed from brittle ceramic blocks, it is shipped separately in padded boxes to prevent breakage and installed in the container on site.

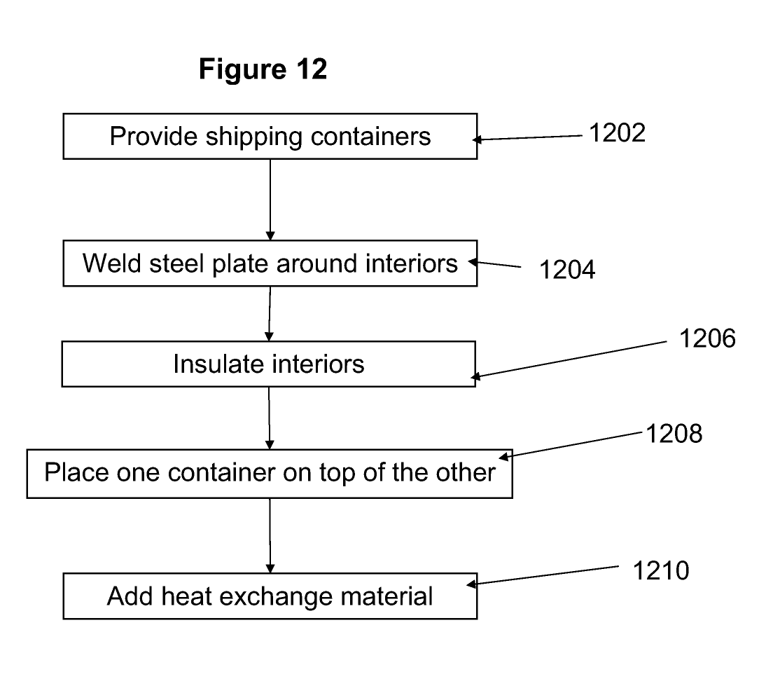

A regenerative thermal oxidiser may be manufactured using heat exchangers manufactured by the method described in relation to FIG. 11. A method for manufacturing a regenerative thermal oxidiser is shown in FIG. 12.

Two shipping containers are provided in step 1202. The containers may be ISO containers with dimensions as described above. In step 1204 steel lining plates are welded around the interiors of the shipping containers. In step 1206, the interiors of the shipping containers are insulated. In step 1208, one of the containers is placed on top of the other. In step 1210 the heat exchange material is added to the shipping containers. The additional features shown in FIGS. 2-10 may also be included in the method.

The examples described above in relation to the figures correspond to regenerative thermal oxidisers for the combustion of VAM from coal mines. However as will be apparent to those of skill in the art, the principles may also be applied to regenerative thermal oxidisers for other purposes including the destruction of unwanted contaminants mixed with air (such as VOCs) or other gases from a variety of sources.

1. A heat exchanger for a regenerative thermal oxidiser comprising
a housing, having a plurality of walls, defining a chamber;
a heat exchange bed, disposed in said chamber in a plane parallel to the longest axis of said chamber, said heat exchange bed defining a first cavity and a second cavity within said chamber, said first cavity and said second cavity extending substantially the length of said longest axis of said chamber, said heat exchange bed having a plurality of channels between said first cavity and said second cavity.

2. The heat exchanger of claim 1, further comprising a passive flow controller in at least one of the first cavity and the second cavity.

3. The heat exchanger of claim 2, said housing having a first opening connecting to said first cavity and a second opening connecting to said second cavity, wherein said first and second openings are in walls of said plurality of walls that are perpendicular to said plane and wherein said first and second openings are in opposing walls of said plurality of walls.

4. The heat exchanger of claim 3, wherein said passive flow controller comprises a protrusion adjacent to said second opening extending from an inner surface of said housing facing said heat exchange bed into said second cavity.

5. The heat exchanger of claim 4, wherein said protrusion is substantially triangular in cross section.

6. The heat exchanger of claim 5, wherein said protrusion extends substantially across the width of said second opening.

7. The heat exchanger of claim 2, wherein said passive flow controller comprises a plurality of vanes located in said first cavity.

8. The heat exchanger of claim 7, wherein said vanes extend outwardly from said heat exchange bed in the direction of said channels and bend towards said first opening in said first cavity.

9. The heat exchanger of claim 8, wherein said vanes of said plurality of vanes extend further from said heat exchange bed in regions further from said first opening.

10. The heat exchanger of claim 1, said housing comprising a shipping container.

11. The heat exchanger of claim 1, said heat exchange bed being formed from a plurality of ceramic blocks said ceramic blocks each having a plurality of channels running therethrough.

12. The heat exchanger of claim 11, wherein at least two of said channels of said plurality of channels running through said ceramic blocks are interconnected.

13. The heat exchanger of claim 3, said heat exchange bed having a first region adjacent to said first opening, a second region adjacent to said second opening and a third region between said first and second regions, wherein said heat exchange bed is thicker in said first and/or second regions than in said third region.

14. A valve assembly for a regenerative thermal oxidiser comprising:
a housing, forming a valve chamber, said housing comprising
an inlet duct opening;
an outlet duct opening;
a first heat exchange bed opening; and
a second heat exchange bed opening,
a valve blade, rotatable around an axis within said chamber
wherein said housing is provided with inwardly facing protrusions that limit the angular position of said valve blade between a first radial position and a second radial position, said protrusions being in contact with said valve blade when said valve blade is in said first or said second position and preventing fluid flow from said inlet duct opening to said outlet duct opening.

15. The valve assembly of claim 14 wherein said inlet duct opening is on an opposing face of said housing to said outlet duct opening.

16. The valve assembly of claim 14 wherein when said valve blade is in an angular position between said first and said second position fluid can flow from said inlet duct opening to said outlet duct opening.

17. The valve assembly of claim 14, wherein the thickness of said valve blade does not substantially vary with radial distance from said axis.

18. The valve assembly of claim 14 further comprising a first heat exchange bed duct connected to said first heat exchange duct opening and a second heat exchange bed duct connected to said second heat exchange bed opening, wherein said first and second heat exchange bed ducts extend outwardly from said first axis and then bend such that first and second heat exchange bed ducts follow parallel paths perpendicular to said first axis

19. The valve assembly of claim 18, further comprising an outlet duct connected to said outlet duct opening, said outlet duct running away from said first axis parallel to said parallel paths of said first and second heat exchange bed ducts and then turning to a direction parallel to said first axis.

20. The valve assembly of claim 19, further comprising a vent located in a plane perpendicular to said first axis, wherein said outlet duct connects to said vent.

21. The valve assembly of claim 14, wherein said outlet duct opening is formed in a surface of said housing perpendicular to said axis to allow fluid flow from said valve chamber parallel to said axis.

22. A heat exchanger according to claim 1 comprising a valve assembly according to claim 14 integrated within said housing of said heat exchanger.

23. A regenerative thermal oxidizer comprising
a first heat exchanger comprising
a housing, having a plurality of walls, defining a chamber;
a heat exchange bed, disposed in said chamber in a plane parallel to the longest axis of said chamber, said heat exchange bed defining a first cavity and a second cavity within said chamber, said first cavity and said second cavity extending substantially the length of said longest axis of said chamber, said heat exchange bed having a plurality of channels between said first cavity and said second cavity;
a second heat exchanger comprising
a housing, having a plurality of walls, defining a chamber;
a heat exchange bed, disposed in said chamber in a plane parallel to the longest axis of said chamber, said heat exchange bed defining a first cavity and a second cavity within said chamber, said first cavity and said second cavity extending substantially the length of said longest axis of said chamber, said heat exchange bed having a plurality of channels between said first cavity and said second cavity;
an inlet;
an outlet;
a valve assembly operable to selectively connect said inlet to said first cavity of either of said first heat exchanger and said second heat exchanger and said outlet to the other; and
a combustion chamber connected between said second cavity of said first heat exchanger and said second cavity of said second heat exchanger.

24. The regenerative thermal oxidiser of claim 23, wherein said first heat exchanger and said second heat exchanger further comprise a passive flow controller in at least one of the first cavity and the second cavity.

25. The regenerative thermal oxidiser of claim 23, further comprising an active flow controller.

26. The regenerative thermal oxidiser according to claim 23, said first heat exchanger being arranged on top of said second heat exchanger.

27. The regenerative thermal oxidiser of claim 23, said valve assembly comprising:
a housing, forming a valve chamber, said housing comprising
an inlet duct opening;
an outlet duct opening;
a first heat exchange bed opening; and
a second heat exchange bed opening,
a valve blade, rotatable around an axis within said chamber
wherein said housing is provided with inwardly facing protrusions that limit the angular position of said valve blade between a first radial position and a second radial position, said protrusions being in contact with said valve blade when said valve blade is in said first or said second position and preventing fluid flow from said inlet duct opening to said outlet duct opening.

28. The regenerative thermal oxidiser of claim 23, having a diesel fired heater in said combustion chamber.

29. The regenerative thermal oxidiser of claim 25, said active flow controller comprising a fan connected to said inlet, wherein said fan has a variable speed drive.

30. A method of manufacture of a heat exchanger for a regenerative thermal oxidiser, said method comprising
providing a shipping container;
lining at least part of the interior of said shipping container with steel plate;
attaching insulation to at least part of said steel plate; and
arranging blocks of a heat exchange material within said shipping container.

31. A method of manufacturing a regenerative thermal oxidiser, said method comprising:
providing a first shipping container and a second shipping container;
lining at least part of the interior of said first shipping container and said second shipping container with steel plate;
attaching insulation to at least part of said steel plate in said first shipping container and said second shipping container;
placing said first shipping container on top of said second shipping container; and
arranging blocks of a heat exchange material within said first shipping container and said second shipping container.
